(19) United States
(12) Patent Application Publication
(10) Pub. No.: US 2002/0157313 A1
(43) Pub. Date: Oct. 31, 2002

(54) DEVICE FOR ESTIMATING SAFETY CONTROL AREA FOR POWER WINDOWS BASED UPON A FULLY OPEN POSITION

(76) Inventors: Fusao Fukazawa, Shizuoka (JP); Keiichi Tajima, Shizuoka (JP); Tsutomu Takiguchi, Shizuoka (JP)

Correspondence Address: Sughrue Mion Zinn MacPeak & Seas PLLC, 2100 Pennsylvania Avenue NW, Washington, DC, 20037-3202, US

(21) Appl. No.: 09/533,676

(22) Filed: Mar. 23, 2000

(30) Foreign Application Priority Data
Mar. 23, 1999 (JP) HEI 11-77155

(51) Int. Cl. E05F 15/02

(52) U.S. Cl. 49/26; 49/28

(57) ABSTRACT

A safety device for a power window which can perform an appropriate safety control operation even immediately after a battery change. An opening and closing speeds detecting portion 35 detects the opening and closing speeds of a windowpane based on voltages VA, VB outputted from a potensiosensor 20 provided on a driving motor 9 for operating the windowpane to open and close, and further detects a fully opened position of the windowpane based on the opening and closing speeds so detected. Then, a fully closed position of the windowpane 1 is estimated referring to opening and closing strokes of the windowpane, whereby a safety control area is set based on this fully closed position. Thus, even in a state resulting just after a battery change in which a fully closed position of the windowpane 1 is not accurately recognized and hence the safety control area is not accurately set, the safety control area can be set highly reliably based on the estimated fully closed position, whereby an accurate safety control operation can be secured for a power window apparatus all the time.

### BACKGROUND OF THE INVENTION

1. Field of the Invention

The present invention relates to power windows designed to be used in vehicles such as automobiles for opening and closing windowpanes by means of driving sources such as motors or the like, and more particularly to a safety device for safely controlling the operation of the windowpanes by detecting a state in which, for example, the hand or head is caught between the windowpane and the window sash.

2. Description of the Related Art

In general, since a power window uses a motor or the like for opening and closing a windowpane of an automotive vehicle, there exists a risk of the hand or head of a passenger of the vehicle being caught between the windowpane and an associated window sash. To cope with this, there has been proposed a safety device for preventing an accident which detects a state in which a foreign object is caught between a windowpane and a window sash of an automotive vehicle and stops the closing or opening operation of the windowpane or opens the windowpane when such a state is detected. In a power window safety device like this, if the safety control operation is performed when the windowpane is fully closed to be in abutment with the sash, there occurs a situation in which the windowpane cannot be closed fully. Therefore, to cope with this, a safety control area for performing a safety control operation is set. That is, an area in the vicinity of the fully closed position of the windowpane is excluded from the safety control area. In a conventional safety control area setting technology like this, the whole opening and closing operation area of the windowpane is detected from the opening and closing positions of the windowpane resulting in conjunction with the opening and closing operations thereof, and an area in the vicinity of the fully closed position of the windowpane is then understood as safe to provide no risk of the fingers or the like being caught between the windowpane and the sash. Thus, the resulting area is set as the safety control area. If the safety control area is set like this, since the safety control operation is not carried out when the windowpane is fully closed, the window can be fully closed.

In setting the safety control area as described above, the fully closed position of the windowpane needs to be detected as described above, and in the conventional method, a point of time is detected as the fully closed position when the driving motor for driving the windowpane to open and close reaches a state in which the driving motor cannot drive the windowpane in the closing direction any further and locks. Normally, this detection of the fully closed position is performed when the power window apparatus is equipped on an automotive vehicle and the power window apparatus is connected to a battery for initial driving thereof, and the detected fully closed position is stored in a memory installed in the microcomputer, whereafter this stored fully closed position is used for performing the safety control operation.

However, in a case where the memory is constituted by a RAM, there may occur a risk of the fully closed position stored in the memory being erased when the battery on the automotive vehicle is replaced with a new one. Due to this, operations of detecting and storing the fully closed position similar to those carried out when the power window apparatus was initially equipped on the vehicle are to be carried out again immediately after batteries are replaced. When this takes place, it is assumed that there may occur a risk of a foreign object being caught between the windowpane and the window sash in conjunction with the closing operation of the windowpane. To cope with this, the function to prevent the catching of a foreign object needs to be provided for a closing operation of the windowpane that is to be carried out just after a battery change.

### SUMMARY OF THE INVENTION

An object of the present invention is to provide a safety device for power windows which can securely prevent catching of a foreign object during a windowpane operation which is carried out just after a battery change.

The present invention provides a safety device for power windows in which a windowpane of a vehicle is operated to open and close by a driving motor, and in which a fully closed position of the windowpane is detected so that an area excluding a vicinity to the fully closed position is set as a safety control area against catching of a foreign object, comprising position detecting means for detecting a fully opened position of the windowpane and fully closed position estimating means for estimating a fully closed position of the windowpane based on the fully opened position, whereby the safety control area is set based on the estimated fully closed position. Here, it is desirable that the position detecting means detects the position of the windowpane based on an amount the driving motor rotates for opening or closing the windowpane, and that a position where the driving motor locks in an opening direction is detected as the fully opened position. In addition, it is desirable that the fully closed position estimating means calculates the fully closed position of the windowpane based on the fully closed position and opening and closing strokes of the windowpane.

In the safety device according to the present invention, even if the fully closed position of the windowpane is not detected and the safety control area is not recognized accurately, the windowpane is fully opened, and a temporary fully closed position of the windowpane is estimated based on the fully opened position. The safety control area is set based on the estimated fully closed position. Since the estimated fully closed position is set, for example, based on the fully opened position and the opening and closing strokes of the windowpane, it can be detected as a highly reliable fully closed position, and therefore, even when the windowpane is first closed after a battery change, the safety control area can be set with high accuracy, whereby an accurate safety control operation can be realized even when the windowpane is first operated to close immediately after the battery change.

### BRIEF DESCRIPTION OF THE DRAWINGS

FIG. 1 is a schematic drawing showing a window opening and closing mechanism for a power window according to the present invention.

FIG. 2 is a front view showing a main part of the window opening and closing mechanism.

FIG. 3 is a perspective view showing a main part of a power window driving portion in an exploded fashion.

FIG. 4 shows drawings explaining a potentiosensor, in which FIG. 4(a) is a plan view of a resistance track plate, and FIG. 4(b) is a side view, partially cut-away, showing a part of the power window driving portion.

FIG. 5 shows diagrams showing an equivalent circuit and output property of the potentiosensor.

FIG. 6 is a block diagram showing the overall construction of a safety device according to the present invention.

FIG. 7 is a diagram showing a relationship between the voltages and the window opening and closing positions for explaining a position detection method at a window position detecting portion.

FIG. 8 is a flowchart for explaining safety operations according to the present invention.

### DETAILED DESCRIPTION OF THE INVENTION

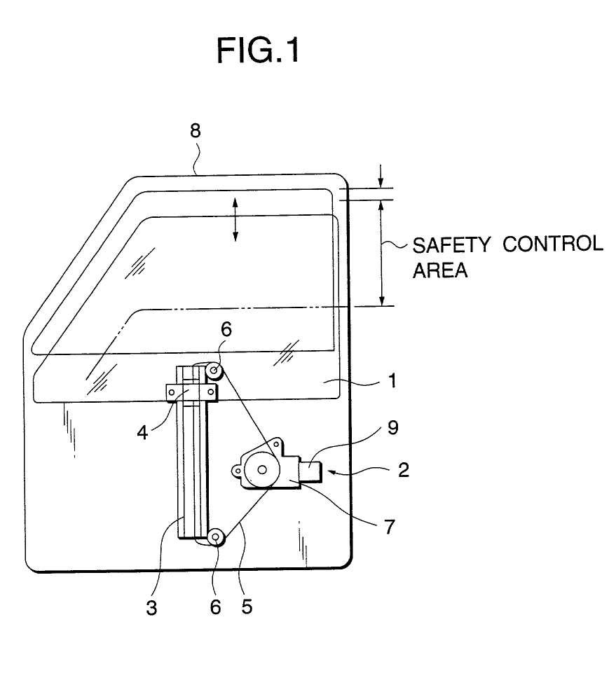

Next, referring to the accompanying drawings, a mode for carrying out the present invention will be described below. FIG. 1 is a drawing showing the typified construction of a power window apparatus to which the present invention is applied, in which a windowpane 1 is operated to open and close by an opening and closing mechanism 2 provided below the window in a lower side of a vehicle body or the door. In other words, a rail 3 is provided in the door in such a manner as to extend vertically, and a slider 4 is held on the rail 3 in such a manner as to slide vertically thereover. A wire 5 is connected to the slider 4, and the wire 5 is wound round pulleys 6 disposed at upper and lower ends of the rail 3 and is then coupled to a power window driving portion 7, whereby when the power window driving portion 7 is driven, the slider 4 is moved vertically via the wire 5. The windowpane 1 is attached to the slider 4, and when it is moved vertically together with the slider 4, the windowpane 1 closes a window space defined by a sash 8. The power window driving portion 7 has a driving motor 9 as a driving source, and when the wire 5 is rotated by virtue of the rotational force of the driving motor 9, the windowpane 1 is moved vertically. For example, when the motor is rotated clockwise, the windowpane is raised, while when the motor is rotated counterclockwise, the windowpane is lowered.

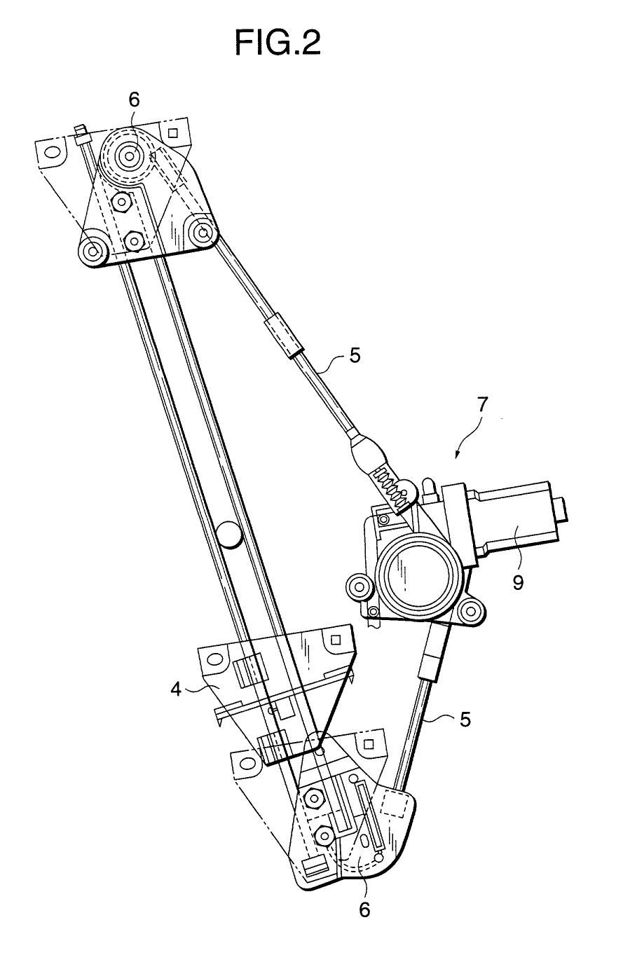

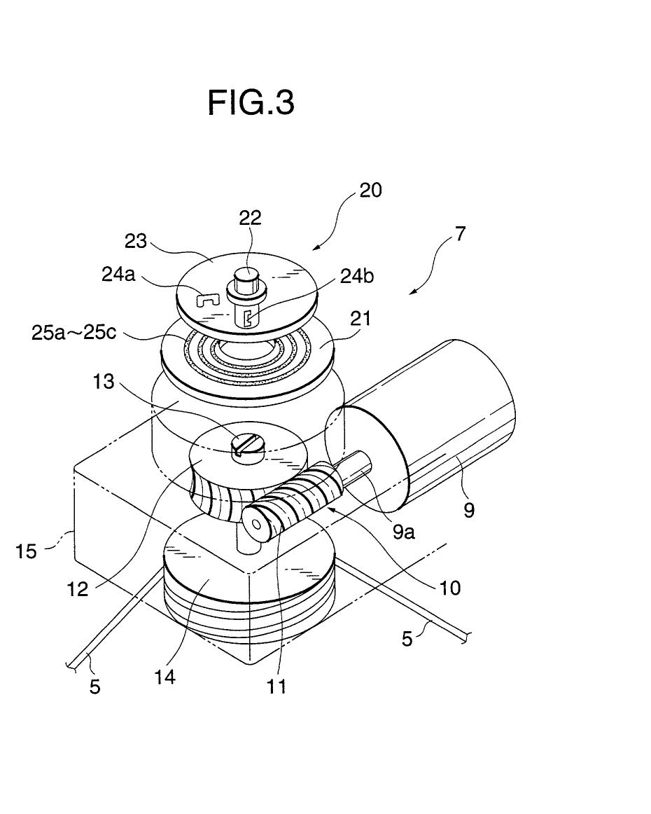

FIG. 2 is a front view of an example of the power window apparatus, and like reference numerals are given to portions corresponding to those described in FIG. 1. As shown in an exploded view in FIG. 3 illustrating the construction of a main part thereof, the power window driving portion 7 comprises the driving motor 9 driven to rotate by virtue of electric power, a speed reducing mechanism 10 for driving the wire by reducing the speed of the rotational output of the driving motor 9 and a potentiosensor 20 for detecting the rotational angular position of an output shaft of the speed reducing mechanism 10. A worm 11 is fixed to one end portion of a rotating shaft 9a of the motor 9, and a worm wheel 12 is brought into mesh engagement with this worm 11, whereby the speed reducing mechanism 10 is constituted. In addition, a pulley 14 is fixed to one end portion of an output shaft 13 adapted to rotate together with the worm wheel 13 for the wire 5 to be wound round. This pulley 14 is installed within a casing 15 which is integrated with the driving motor 9. Therefore, when the driving motor 9 is driven, the pulley 14 being rotated via the speed reducing mechanism 10, the windowpane 1 is moved by the wire 5 in an opening or closing direction. In this mode for carrying out the invention, the windowpane 1 completes its whole opening or closing stroke when the pulley 14 rotates three to four times.

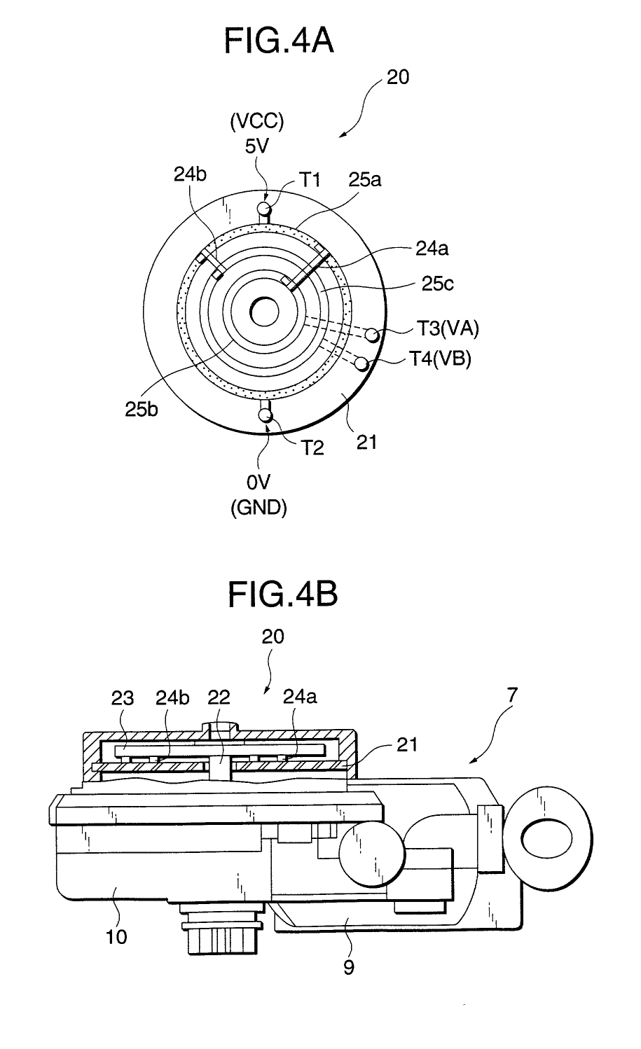

As shown in FIG. 4, the potentiosensor 20 is disposed at a position on the opposite side to the pulley 14 in the casing 15. Integrally provided on this potentiosensor 20 are a circular resistance track plate 21 disposed and fixedly supported at a position coaxial with the output shaft 13 of the worm wheel 12, a potentioshaft 22 penetrating through a center hole in the resistance track plate 21 and integrally connected to the output shaft 13 in its rotating direction, and a rotating plate 23 integrally supported on the potentioshaft 22 and having a pair of conductive brushes 24a, 24b adapted to be moved on the resistance track plate 21 in the rotating direction. In addition, three circular potentiotracks 25a to 25c are formed on a side of the resistance track plate 21 opposite to the side thereof where the rotating plate 23 is provided.

FIG. 4(a) is a pattern drawing showing the potentiotracks 25a to 25c provided on the resistance track plate 21, and the three circular potentiotracks 25a to 25c are disposed concentrically on the surface of the variable resistance track plate made of an insulation material. Of the three tracks the inner track 25a is formed of a carbon material as a resistance track and the other two outer tracks 25b, 25c are formed of a good conductive material as conductor tracks. Terminal portions T1, T2 are provided on the resistance track 25 at two circumferential positions which are opposed to each other at right angles, and power supplies VCC (5V) and GND (0V) are connected to the resistance track 25a via these terminal portions T1, T2. In addition, output voltages VA, VB, which will be described later, are designed to be taken out from terminal portions T3, T4, respectively. The rotating plate 23 is formed into a disc centering at the potentioshaft 22, and the conductive brushes 24a, 24b are fixedly supported on the rotating plate 23 at circumferential positions which form a right angle relative to the center thereof. The conductive brush 24a is designed to short-circuit the resistance track 25a and the conductor track 25b, and the conductive brush 24b to establish an electrical continuity between the resistance track 25a and the conductor track 25c, the resistance track 25a and the conductor tracks 25b, 25c being provided on the resistance track plate 21.

Consequently, when the driving motor 9 is driven, the rotational driving force of the rotating shaft 9a being transferred to the worm wheel 12 from the worm 11, then the output shaft 13 being rotated, the pulley 14 drives the wire 5 to thereby operate the windowpane 1 to open or close, and at the same time as this takes place, the rotating plate 23 is rotated, whereby the conductive brushes 24a, 24b are rotated along the surface of the resistance track plate 21. Due to this, with the two conductive brushes 24a, 24b which are brought into contact with the resistance track 25a at one of the ends thereof, the respective contact positions with the resistance track 25a are shifted in the rotating direction, and in association with this, the output voltages VA, VB resulting from the division of the supply voltage VCC are outputted to the terminal portions T3, T4 of the conductive tracks 25b, 25c, respectively, and these outputs vary as the conductive brushes 24a, 24b rotate. When this takes place, since the two conductive brushes 24a, 24b are disposed at the positions which form a right angle, the phases of outputs therefrom are also deviated from each other 90 degrees relative to the rotating angle of the rotating plate.

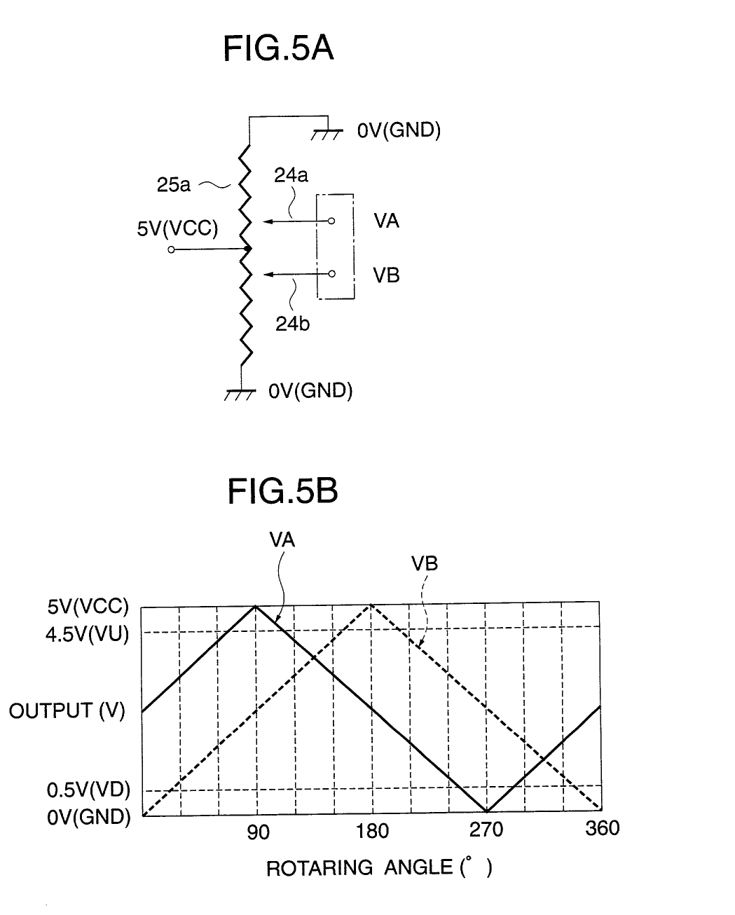

Namely, FIG. 5(a) is an equivalent circuit diagram of the potentiosensor 20, and FIG. 5(b) is a diagram showing the output property thereof. In FIG. 5(b), the axis of abscissa represents the rotating angle of the rotating plate, and the axis of ordinates voltage values of the output voltages VA, VB outputted from the potentiosensor 20. As is seen from FIG. 5(b), the output voltage VA of the conductive brush 24a indicated by a solid line and the output voltage VB from the conductive brush 24b indicated by a broken line are deviated from each other 90 degrees, and it is characteristic of the potentiosensor 20 that the output voltages VA, VB vary between VCC (5V) and GND (0V) as the rotating plate 23 rotates.

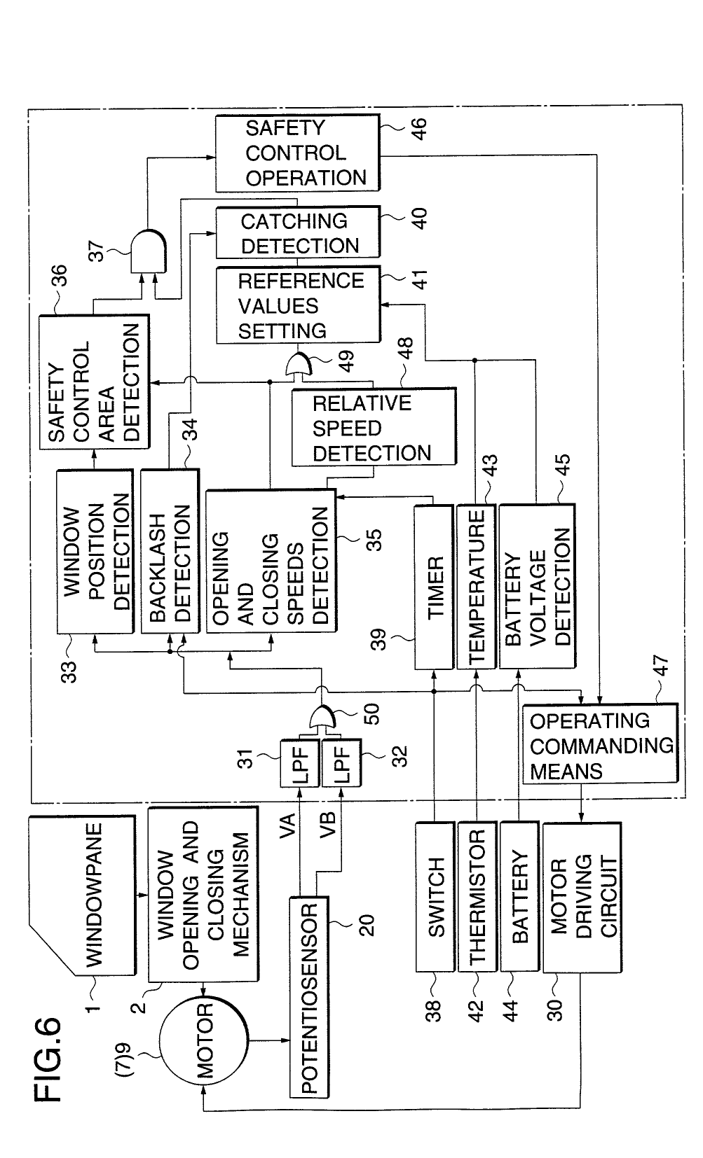

FIG. 6 is a block diagram showing the overall construction of a safety device according to the present invention which adopts the potentiosensor 20. The power window driving portion 7 is driven to rotate clockwise and counterclockwise by a motor driving circuit 30. Then, the windowpane is operated to open and close in conjunction with the rotation of the driving motor 9, and the rotational angular position of the driving motor 9 is outputted from the potentiosensor 20 as the two output voltages VA, VB. These output voltages VA, VB are passed through low pass filters or LPF's 31, 32, respectively, to remove noise thereon and are then inputted, respectively, into a windowpane position detecting portion 33, a backlash detecting portion 34 and an opening and closing speeds detecting portion 35 via an OR gate 50.

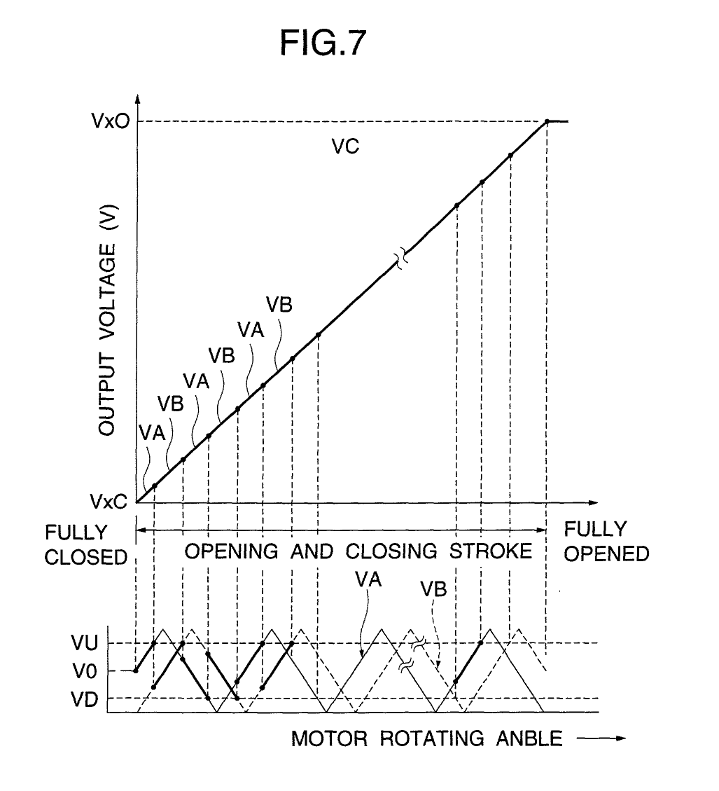

The windowpane position detecting portion 33 detects the position of the windowpane which is being operated to open or close. The windowpane position detecting portion 33 compares, as shown in FIG. 7, an upper limit voltage VU and a lower limit voltage VD which are preset between VCC (5V) and GND (0V) with the output voltages VA, VB from the potentiosensor 20, respectively, based on the output voltages VA, VB, and selects the output voltages VA, VB indicated by solid lines in a lower part of FIG. 7 which stay between the voltages VU and VD. Moreover, these selected output voltages VA, VB are sequentially added up as the motor rotates, whereby a continuous output voltage Vx is obtained which is shown in an upper part of FIG. 7. Thus, the position of the windowpane which is being operated to open or close is detected through this voltage Vx. A description of one method for adding up the output voltages VA, VB is provided in JPA H11-077154, the contents of which are hereby incorporated herein by reference.

The fully opened and closed positions of the windowpane detected at the windowpane position detecting portion 33 are outputted to a safety control area detecting portion 36. This safety control area detecting portion 36 detects the safety control area from the fully opened and closed positions of the windowpane so inputted thereinto. This safety control area is, as described above, an area ranging from the fully opened position of the windowpane to the position just before the windowpane is fully closed, and the safety control is performed against catching of a foreign object only within this area. In other words, in a state just before the windowpane is fully closed, the windowpane 1 is brought into contact with the sash 8, and a contact resistance produced then creates a state similar to the state in which a foreign object is caught. Then, as will be described later, a foreign object catching detecting portion detects this contact resistance producing state as the foreign object catching state, and therefore when this happens, the windowpane 1 cannot be fully closed. Thus, the safety control area is set such that such a risk of the windowpane 1 being not fully closed can be avoided. Here, in this safety control area detecting portion 36, a point of time when a state results in which the opening or closing speed of the windowpane 1 becomes 0 or nearly 0 is detected based on the opening or closing speed of the windowpane 1 moving in the opening or closing direction which is outputted from the opening and closing speeds detecting portion 35, and it is then judged that the windowpane 1 cannot be operated to open or close any further at this point of time with the driving motor 9 being in the locking state, and this state is detected as the fully opened or closed position. An output from this safety control area detecting portion 36 is inputted to one of input terminals of an AND gate 37.

On the other hand, the backlash detecting portion 34 detects a backlash in a closing operation of the windowpane taking place after an opening operation thereof through change in output voltage from the potentiosensor 20 in association with a backlash generated when a power window opening/closing switch is turned on and the windowpane is operated reversely between the clockwise and counterclockwise. In addition, the opening and closing speeds detecting portion 35 detects the speed of the windowpane when it is operated to open or close. In order to detect the speed of the windowpane so operated, in the opening and closing speeds detecting portion 35, a certain time period is detected by means of a timer 39 since the window opening/closing switch 38 is turned on, and an operation is carried out using voltage changes outputted from the potentiosensor 20 during this certain time period, whereby an absolute speed of the windowpane when it is operated to open and close is detected. Moreover, a relative speed which is a changed speed from the absolute speed is detected at a relative speed detecting portion 48, and the absolute speed and relative speed are outputted to a reference value setting means 41. Then, making use of detection outputs from the backlash detecting portion 34 and the opening and closing speeds detecting portion 35, catching of a foreign object by the windowpane is detected at the foreign object catching detecting portion 40. In this foreign object catching detection, when a backlash is generated, the absolute speed and relative speed resulting when the windowpane is operated to close are compared with a reference absolute speed and reference relative speed of the reference setting portion 41, and when the closing speed becomes slower than the respective reference speeds, it is detected that the foreign object catching state exists. The respective reference speeds are preset, but the respective reference speeds are corrected while referring to outputs outputted, respectively, from a temperature detecting portion 43 using a thermistor 42 and a battery voltage detecting portion 45 for detecting the voltage of a battery 44, lest the respective preset reference speeds be varied by change in temperature or battery voltage.

The AND gate 37 outputs a safety control operation signal within the safety control area and when catching of a foreign object is detected therein. A safety control operating portion 46 outputs an operation command to an operation commanding portion 47 upon receipt of the safety control operation signal, and this operation commanding portion 47 controls the motor driving circuit 30 to rotate the driving motor 9 a predetermined amount in the reverse direction, i.e., the driving motor 9 is rotated in the opening direction the predetermined amount, whereby when the hand or fingers of the passenger are caught between the windowpane 1 and the sash 8, the windowpane is operated to open without any delay, and the hand or fingers so caught are then released from such a caught condition, the safety control of the power window being thus carried out.

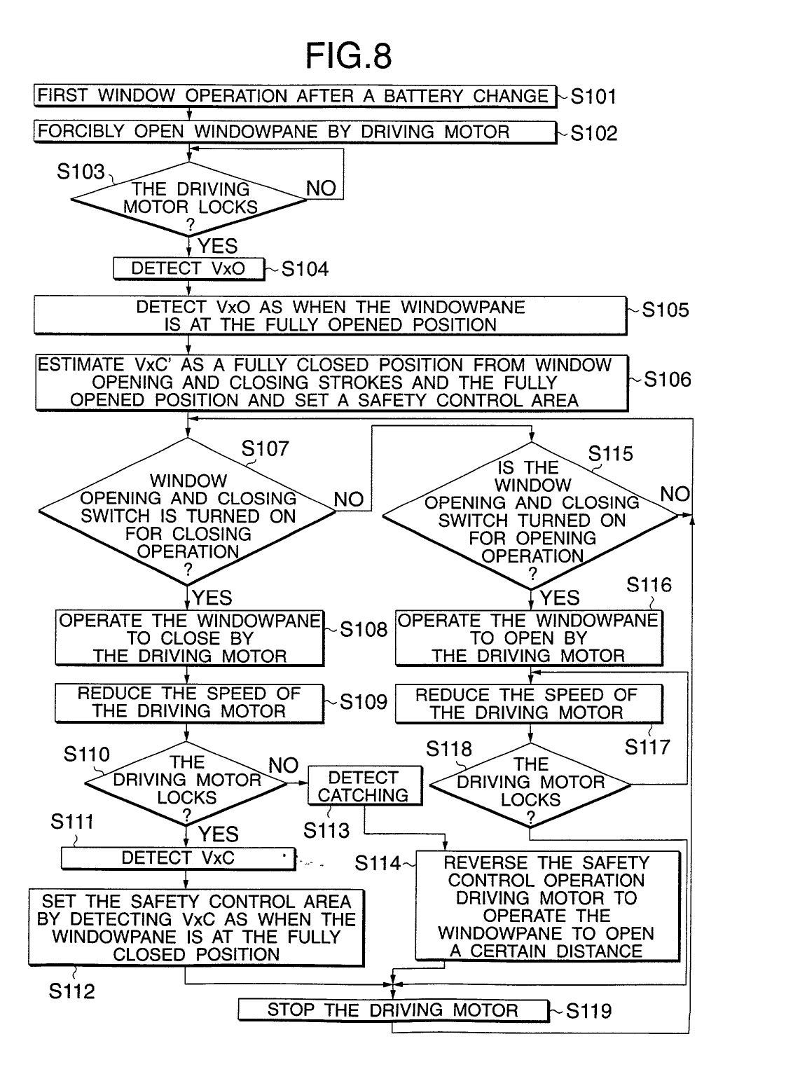

FIG. 8 is a flowchart for describing the operations of the power window apparatus. When this power window apparatus, as is described above, is first equipped on an automotive vehicle, once the windowpane is fully closed and its fully closed position is stored in the memory (RAM) of the microcomputer, this fully closed position is utilized as the reference in setting the safety control area at the safety control area detecting portion 36. In a case where the user of the automotive vehicle replaces batteries, however, the stored fully closed position is erased. To cope with this, when the windowpane is first operated after the replacement of batteries (S101), the microcomputer forcibly operates the windowpane in the fully opening direction (S102). Then, when the opening speed of the windowpane becomes 0, in other words, when the driving motor 9 is detected as locking (S103), the safety control area detecting portion 36 detects this point of time as the fully opened position of the windowpane, and it detects the output voltage VxO of the output property Vx obtained from the potentiosensor 20 at this time as shown in FIG. 7 as the voltage when the windowpane is fully opened (S104, S105). Following this, the voltage VxC′ when the windowpane is at the fully closed position is found by applying this VxO to the voltage range of a pre-recognized stroke Lx ranging from the fully opened position to the fully closed position of the windowpane or, in other words, the output voltage Vx obtained from the potentiosensor 20 which corresponds to the stroke of the windowpane. The value of the stroke Lx may correspond to a particular type of vehicle, and be stored in a non-volatile memory, for example. Therefore, this voltage VxC′ is stored as a temporary fully closed position and the safety control area is then set based on this temporary fully closed position (S106).

Thereafter, wait for an input from the window opening/closing switch 38 (S107), and when the switch is turned on for the closing direction, the driving motor 9 is driven to rotate in the closing direction, whereby the windowpane is operated to close (S108). Then, when the speed of the windowpane is reduced (S109), if it is detected that the driving motor 9 has locked (Si10), the safety control area detecting portion 36 detects this point of time as the fully closed position of the windowpane, and the output voltage VxC of the output property Vx shown in FIG. 7 which is obtained from the potentiosensor 20 at that time is detected as the voltage when the windowpane is at the fully closed position (S111). Then, the previously stored voltage VxC′ is rewritten by this new output voltage Vx. This allows the fully closed position of the windowpane to be stored in the memory and enables highly accurate setting of the safety control area (S112). Therefore, the motor 9 is stopped thereafter (S119), and control is transferred back to step S107.

In addition, in order to prevent catching of a foreign object from occurring in the first window closing operation to set the fully closed position of the windowpane, in step S109, the speed of the driving motor 9 is reduced, and in a case where the driving motor does not lock at that time (S110), the opening or closing speed of the windowpane is detected at the opening and closing speeds detecting portion 35 and the relative speed thereof is detected at the relative speed detecting portion 40, whereby a foreign object catching detection similar to that normally carried out is carried out at the catching detecting portion 40 (S113), and the safety control operation is carried out based on the result of this detection. Namely, when catching of a foreign object is detected, the driving motor 9 is operated to rotate in the opening direction a certain distance to thereby release the catching of a foreign object (S114). When this takes place, the temporary closed position is being set from the previously detected fully opened position of the windowpane at the safety control area detecting portion 36, and since this fully closed position is detected based on the opening and closing strokes of the windowpane, the position so detected is highly reliable, and therefore even in the operation based on the temporary closed position, the safety control operation can be carried out at the same level as that based on the actual fully closed position, the catching of a foreign object being thereby prevented effectively.

In step S107, when the window opening/closing switch 38 is turned on for the opening direction (S115), the windowpane is operated to open by the driving motor 9 (S116), and when the closing speed of the windowpane is reduced (S117) and becomes 0, in other words, when it is detected that the driving motor 9 has locked (Si18), the driving of the driving motor 9 is stopped when the locking is detected (S119). This allows the windowpane to be normally opened or closed thereafter.

Here, in the above mode for carrying out the invention, the fully opened position of the windowpane is detected as a position resulting when the opening or closing speed of the windowpane becomes nearly 0 and the driving motor locks, but since the output voltage Vx from the potentiosensor 20 is naturally put in a state in which it is fixed to a predetermined voltage on the lower side, the fully opened position can also be detected by monitoring change in output voltage Vx. In addition, the opening and closing strokes of the windowpane are used in estimating the temporary closed position of the windowpane, but on top of the utilization of the opening and closing strokes which are detected by using the change in output voltage from the potentiosensor 20, the fully closed position can be estimated by using an amount the driving motor rotates which is closely related to the opening and closing strokes of the windowpane.

As has been described heretofore, the present invention comprises the position detecting means for detecting the fully opened position of the windowpane and the fully closed position estimating means for estimating the fully closed position of the windowpane based on the detected fully opened position of the windowpane, wherein the safety control area is designed to be set based on the estimated fully closed position where the safety control operation is carried out against catching of a foreign object by the windowpane, and therefore, even when the fully closed position of the windowpane is not accurately recognized as often happens immediately after a battery change, so that the safety control area is not accurately set, the safety control area can be set highly reliably based on the estimated fully closed position, whereby even in the first window closing operation after a battery change, the accurate safety control operation can be advantageously secured.

What is claimed is:

1. A safety device for power windows in which a driving motor is operated to open and close windowpane of a vehicle, and in which a fully closed position of the windowpane is detected in order to set a safety control area for preventing catching of a foreign object, comprising:
a first means for detecting a fully opened position of said windowpane; and
a second means for estimating a fully closed position of said windowpane based on said fully opened position,
wherein said safety control area is set based on said fully closed position estimated by said second means.

2. A safety device for power windows as set forth in claim 1, wherein said first means detects the position of said windowpane based on an amount said driving motor rotates for opening or closing said windowpane, and further wherein a position at which said driving motor locks in an opening direction is detected by said first means as said fully opened position.

3. A safety device for power windows as set forth in claim 1, wherein said second means estimates said fully closed position of said windowpane based on the fully opened position and opening and closing strokes of said windowpane.

4. A safety device for power windows as set forth in claim 2, wherein said second means estimates said fully closed position of said windowpane based on the fully opened position and opening and closing strokes of said windowpane.

5. A safety device for power windows in which a driving motor is operated to open and close windowpane of a vehicle, and in which a fully closed position of the windowpane is detected in order to set a safety control area for preventing catching of a foreign object, comprising:
a first means for detecting a position of said windowpane including a fully opened position of said windowpane; and
a second means for estimating a fully closed position of said windowpane based on said fully opened position,
wherein an estimated safety control area is set based on said fully closed position estimated by said second means, and
further wherein said estimated safety control area is used as said safety control area until an actual fully closed position is detected by said first means, afterwhich an actual safety control area is determined from said actual fully closed position.

6. A safety device for power windows as set forth in claim 5, wherein said first means detects the position of said windowpane based on an amount said driving motor rotates for opening or closing said windowpane, and further wherein a position at which said driving motor locks in an opening direction is detected by said first means as said fully opened position.

7. A safety device for power windows as set forth in claim 5, wherein said second means estimates said fully closed position of said windowpane based on the fully opened position and opening and closing strokes of said windowpane.

8. A safety device for power windows as set forth in claim 6, wherein said second means estimates said fully closed position of said windowpane based on the fully opened position and opening and closing strokes of said windowpane.
